(19) United States
(12) Patent Application Publication
(10) Pub. No.: US 2004/0128492 A1
(43) Pub. Date: Jul. 1, 2004

(54) Memory device for assistant execution of computer program in semi-opening or all-opening machine

(75) Inventor: Szu-Chung Wang, Taipei (TW)

Correspondence Address: BRUCE H. TROXELL, SUITE 1404, 5205 LEESBURG PIKE, FALLS CHURCH, VA, 22041, US

(73) Assignee: Mitac Technology Corp.

(21) Appl. No.: 10/329,451

(22) Filed: Dec. 27, 2002

(51) Int. Cl. G06F 9/00

(52) U.S. Cl. 713/1

(57) ABSTRACT

A memory device for assistant execution of computer program in semi-opening or all-opening machine is to apply a memory device in notebook computer to store basic driving program, and the main objective of the invention is to execute basic function by reading the basic driving program stored in the memory device under the situations when the notebook computer is semi-opened or all-opened such that, when the notebook of prior arts is operated, it can avoid the required step-by-step procedure for opening and entering the operation system, and the shortcomings of inconvenience and time-consumption in application may be overcome.

### 1. FIELD OF THE INVENTION

The invention relates to a memory device for assistant execution of computer program in semi-opening or all-opening machine, particularly to a memory device, in which a basic driving program is read to execute basic function for a notebook computer used under semi-opening or all-opening state.

### 2. BACKGROUND OF THE INVENTION

Accordingly, since the technology of computer and internet has progressed into a fashion, so the twenty first century has already been described as an “E-Generation”, which means that the computer internet has already become part of our lives; since the difference of the selling price between the notebook computer and the traditional desktop computer is shortened, so the former one comes from the back and has the trend to replace the desktop computer and, currently, the notebook computer increasingly has the trend of being light, thin, short, and small, and its function also increasingly appears stronger but, during the past, when a notebook computer is initialized, it has to be opened step-by-step to load in the operation system so, in operation, it causes the situations of inconvenience and time-consumption and, because the function we use sometimes is only the partial function of the notebook computer and it is unnecessary to open the all hardware device and operation system, such as playing CD or MP3 music, and a specific program has to be applied to execute such function, but this specific program is unable to use under the semi-opening state of the computer (i.e., the operation system is unloaded; because the capacity of EEPROM inside the notebook computer is too small, it is impossible to load in the specific program completely), so the invention is generated to solve such problem.

### SUMMARY OF THE INVENTION

The main objective of the invention is aimed for solving the shortcoming of the prior arts; namely, a notebook has to be opened completely to be able to execute the basic functions such as playing CD or MP3 music, so it is inconvenient and time-consuming on application and, after longtime conceiving, the inventor has studied out a driving program and its relative controlling device, both which are tested and verified continuously, such that a memory device of a notebook computer to store basic driving program has finally been obtained; briefly, the main objective of the invention is to make a notebook computer that is used under a semi-opening or all-opening state been able to execute basic function by reading the basic execution program stored in the memory device.

Another objective of the invention is to load different driving programs into the memory device according to the different requirements requested by the user, such that the basic functions (for example, playing CD or MP3 music) may be executed when the notebook computer is under semi-opening or all-opening state.

For your esteemed members of reviewing committee to further understand and recognize the structural objective and function of the invention, a detailed description incorporated with drawings is presented as follows.

### BRIEF DESCRIPTION OF THE DRAWINGS

FIG. 1 is a structural illustration for executing a computer program according to the invention under semi-opening or all-opening state.

FIG. 2 is a floating chart for illustrating the steps in executing a computer program according to the invention under semi-opening or all-opening state.

### DETAILED DESCRIPTION OF THE INVENTION

A preferable embodiment of the invention is described in cooperation with corresponding drawing and is presented as the follows.

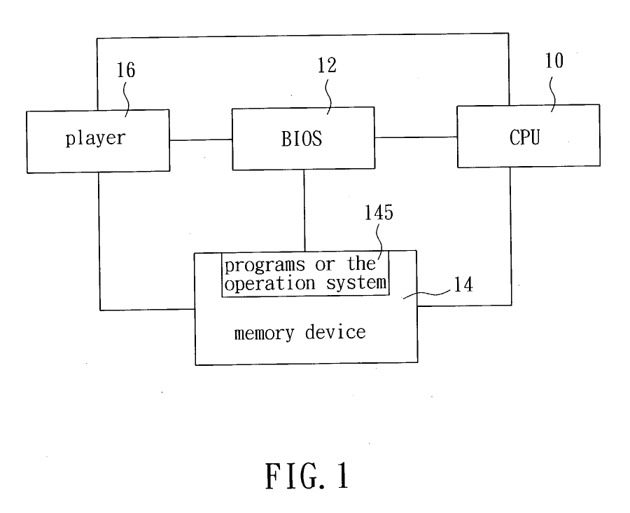

Please refer to FIG. 1, which is a structural illustration for executing a computer program according to the invention under semi-opening or all-opening state, wherein a CPU (Central Processing Unit) 10 is responsible for the operational treatment of the executive program and controlling the signal flow-path of each device, and the signal controlling lines of the CPU 10 are respectively connected to the firmware (BIOS) 12, the memory device 14, and a player 16. Many parameter data are stored inside the firmware 12 for communicating and controlling various devices and are able to be verified according to different requirement requested by the user. In the present invention, the functions of the firmware 12 are to communicate the processing data between the programs or the operation system 145 stored in both CPU 10 and memory device 14 and execute the machine-starting operation, and the firmware 12 will initialize the all basic devices and test them, wherein the basic devices includes: the chipset, the memory, and the access controller, etc.

The said firmware 12 is connected to a memory device 14 through a connection line, and the memory device 14, which includes: PCMCIA of notebook computer, memory stick card, and compact flash card, etc., and which may be arranged in a computer by building-in or sticking-in manner, and specific program or operation system (OS) 145 may be pre-stored in the memory device 14 and made a controlling connection by the CPU 10, and different driving programs may be loaded into the memory device 14 according to the different requirements requested by the user, such that different basic functions may be executed under the situation that the notebook computer is semi-opened or all-opened.

After opening the notebook computer, the operation system (such as Windows) may be unopened and be under a semi-opening state, while the player 16 may use the program or operation system 145 stored in the memory device 14 to drive the player 16 and, with this manner, the problem of being unable to use the player 16 when the notebook is under semi-opening state may be solved, because the capacity size of the EEPROM in the interior of a notebook is too small to be able to load in the specific program completely, and the player 16 includes the devices: CD player, MP3 player, etc., such that the function for using the player 16 may be achieved under the semi-opening state.

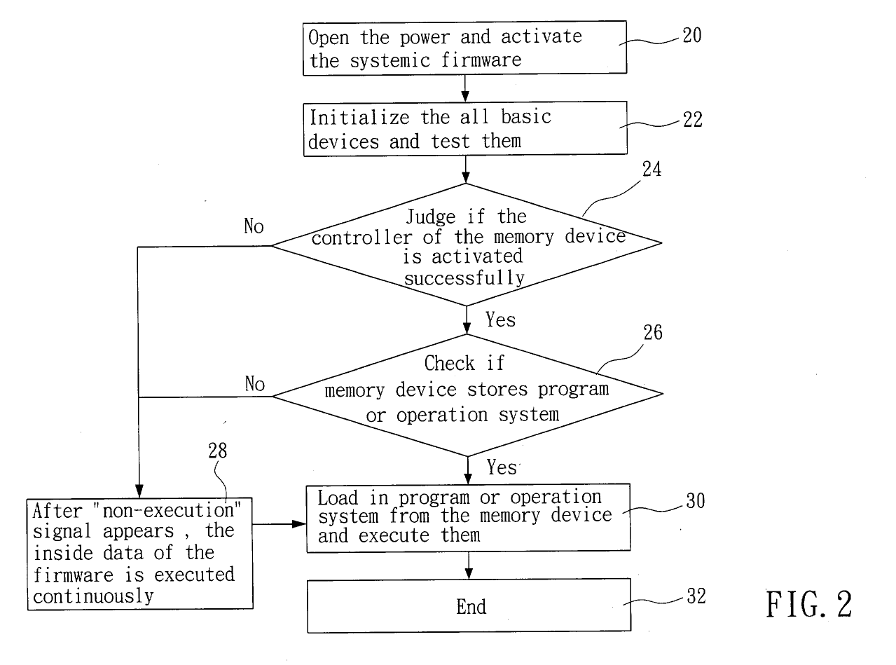

Please refer to FIG. 2, which is a floating chart for illustrating the steps in executing a computer program according to the invention under semi-opening or all-opening state, and the floating chart includes following steps:

20 Open the power and activate the systemic firmware.

22 Initialize the all basic devices and test them, wherein the basic devices include: chipset, memory, access controller, etc.

24 Judge if the controller of the memory device is activated successfully, and judge if the memory device is activated successfully according to the judgment made from the checking code at the most front position of the memory; for example: if the most front checking code is 0, then it represents the activation is not achieved yet and, if the most front checking code is 1, then it represents the activation is succeeded already, so one choice is made according to the setting up of the program.

26 Check if the memory device stores program or operation system.

28 After “non-execution” signal appears, the inside data of the firmware is executed continuously, that is, the opening operation is executed normally.

30 Load in program or operation system from the memory device and execute them.

32 End.

From above said steps, the computer program may be executed completely when the machine is under semi-opening or all-opening state wherein, if the executing result of step 24 is negative, then jump to step 28 for execution, and step 32 is again executed for making an end and, if the executing result of another step 26 is negative, then jump to step 28 for execution, and step 32 is executed again for making an end.

Summarizing above description, the structural characteristics and each embodiment have already been described in detail, but the invention is not used in notebook computer only, because it may be further applied in memory device, capable of sticking and expanding, of the traditional desktop computer or the personal digital assistant (PDA), so it sufficiently shows that the invention deeply possesses the progressiveness of execution in both objective and function and extremely has the application value for industry, and the invention is an application never seen in current market so, according to the spirit said in the patent law, the invention is completely fulfilled with the merits of a new-typed patent.

What is claimed is:

1. A memory device for assistant execution of computer program in semi-opening or all-opening machine includes:
a central processing unit, which is responsible for the operational treatment of the execution program and controlling the signal flow-path of each device;
a firmware (BIOS), which communicates the processing data between the central processing unit and the program and executes the opening operation;
a memory device, which is arranged in a computer by building-in or sticking-in manner, and in which specific program or operation system is stored, and which is made a controlling connection by the central processing unit for making the accessing action of the data; and
a player, which is driven by a specific program to generate the playing function.

2. The memory device for assistant execution of computer program in semi-opening or all-opening machine according to claim 1, wherein the firmware executes the initialization of the basic devices and tests them during the opening period.

3. The memory device for assistant execution of computer program in semi-opening or all-opening machine according to claim 1, wherein the basic devices include: chipset, memory, and access controller, etc.

4. The memory device for assistant execution of computer program in semi-opening or all-opening machine according to claim 1, wherein the player includes: CD player, MP3 player, etc.

5. The memory device for assistant execution of computer program in semi-opening or all-opening machine according to claim 1, wherein the memory device is a PCMCIA of notebook computer.

6. The memory device for assistant execution of computer program in semi-opening or all-opening machine according to claim 1, wherein the memory device is a memory stick card.

7. The memory device for assistant execution of computer program in semi-opening or all-opening machine according to claim 1, wherein the memory device is a compact flash card.

8. An execution method for assistant execution of computer program in semi-opening or all-opening machine includes the following steps:
a. Open the power and activate the systemic firmware;
b. Initialize the all basic devices and test them;
c. Judge if the controller of the memory device is activated successfully;
d. Check if the memory device stores program or operation system;
e. After “non-execution” signal appears, the inside data of the firmware is executed continuously;
f. Load in program or operation system from the memory device and execute them; and
g. End.

9. The execution method for assistant execution of computer program in semi-opening or all-opening machine according to claim 8 wherein, if the execution result of step c is negative, then jump to step e for execution, and step g is again executed for making an end.

10. The execution method for assistant execution of computer program in semi-opening or all-opening machine according to claim 8 wherein, if the execution result of step d is negative, then jump to step e for execution, and step g is again executed for making an end.

11. The execution method for assistant execution of computer program in semi-opening or all-opening machine according to claim 8, wherein the basic devices include: chipset, memory, and access controller, etc.

12. The execution method for assistant execution of computer program in semi-opening or all-opening machine according to claim 8, wherein step c judges if the memory device is opened successfully according to the checking code at the most front position of the memory.
